(19) United States
(12) Patent Application Publication
(10) Pub. No.: US 2016/0341546 A1
(43) Pub. Date: Nov. 24, 2016

(54) System and Method for Determination of Distance Between Two Points in 3-Dimensional Space

(71) Applicants: Tae Hwi An, Philadelphia, PA (US); Austin Small, Lower Gwynedd, PA (US)

(72) Inventors: Tae Hwi An, Philadelphia, PA (US); Austin Small, Lower Gwynedd, PA (US)

(21) Appl. No.: 15/010,007

(22) Filed: Jan. 29, 2016

Related U.S. Application Data
(60) Provisional application No. 62/162,890, filed on May 18, 2015.

(51) Int. Cl. G01B 11/14; G01C 3/08; G01D 5/26

(52) U.S. Cl. CPC G01B 11/14; G01D 5/26; G01C 3/08

(57) ABSTRACT

A device for determining the distance between two points on a surface or surfaces in 3-dimensional space, regardless of the orientation of the points relative to the device, provided an unobstructed line-of-sight between the device and both points. The device includes two distance measuring range finders that are joined by a hinge. The hinge includes a rotary encoder for measuring the angular displacement of the two sensors. By utilizing the distance measurements that each range finder relays, as well as the angular displacement measured by the rotary encoder, the microcontroller determines the final length between the two points and displays it through a display screen.

This application claims the benefit of U.S. Provisional Application No. 62/162,890 filed on May 18, 2015, the contents of which are incorporated herein by reference.

### FIELD OF THE INVENTION

The present invention relates to a system and method for distance measurement. More specifically, the present invention relates to a system and method for finding the distance between two points on any surface or surfaces in 3-dimensional space.

### BACKGROUND OF THE INVENTION

Laser range finding technology has been widely used in engineering, construction, architecture, and other fields of work that require contactless measurement of spatial relationships. The traditional rangefinder, which is in widespread use, is mainly capable of finding the distance between an arbitrary point and the user.

With the traditional laser rangefinder technology, the user must situate oneself at one of the two points of interest and then proceed to find the distance between oneself and the other point in question, which must reside on a surface. However, this method of finding the distance between two points involves the physical limitation that the user must change locations in order to situate oneself at one of the two points, and depending on the two points of interest, this may be physically impossible, inconvenient, or time-consuming. Furthermore, it would be desirable that the distance between two points could be learned instantaneously, rather than after the user has changed locations.

A further implementation of the traditional laser finder technology allows the user to find the height of a specified point, a specific type of distance that is completely vertical, relative to the user. The “Pythagoras Function” is implemented, where the user measures the distance between oneself and the bottom of the object and then the distance between the user and the top of the object, provided that the bottom of the object lies at the same elevation as the user. From these two lengths, representing one leg and the hypotenuse of a right triangle, the function is applied to find the length of the second leg, which represents the height of the point above the user. This function offers more flexibility in that the user is not required to re-situate oneself; however, the distance in question may only be the height, and other lengths that are not are completely vertical cannot be measured through the use of this technology.

An alternative design disclosed by Chien et al. (U.S. Pat. No. 7,304,727) is a rangefinder also capable of finding the height between two points without the user being required to re-situate oneself. This technology operates through the use of an inclinometer, rather than the Pythagoras theorem. The device measures the height of the specified point by knowing the angular displacement of the rangefinder from a horizontal position as well as the line-of-sight distance between the user and point in question. The utilization of the inclinometer offers the flexibility that even if there is an obstacle that is in the way between the base of the object and the user, the height of the object may still be determined, which was previously impossible with the simple range finder and the Pythagoras function.

However, even the utilization of the inclinometer has limitations in determining lengths other than the height. The inclinometer can only measure the altitude angle, not the azimuth angle, and thus only serves its purpose under specific point orientations. That is, if the two points in question are not vertically aligned, the inclinometer serves no purpose in finding the horizontal component of the displacement between the two points.

An alternative design disclosed by Pirlet-Robert A. (U.S. Pat. No. 4,227,813) involves a setup with two emitted beams whose axes define a known angle by using a deflector that guides the two beams to two separate points on an object whose dimensions are in question. The two light rays are reflected by the object and are observed by a receiver. The dimension is calculated from the angles between the beams. While this setup can measure the distance between any two points on a surface, this proposed setup requires a deflector and a fairly elaborate setup, which renders the system immobile. Therefore, in order to fully utilize this technology, the sensitive system must be carefully set up, and the system does not offer ruggedness, flexibility of application, and transportability.

### SUMMARY OF THE INVENTION

Contrary to the prior art systems above, in at least one embodiment, the present system and method provide the capability of finding the distance between two points residing on a surface or surfaces in space with ease and accuracy, where the user is not required to change position. Furthermore, in at least one embodiment, the present system and method provide the capability of finding the distance between two points in space with ease and accuracy, regardless of the orientation of the length in question. Additionally, in at least one embodiment, the present system and method allows the finding of the distance between two points on a surface or surfaces, in any plane orientation, without a sensitive component like an inclinometer. In at least one embodiment, the present invention provides a system that is self-contained and is insensitive to exterior influences and is further highly transportable and requires virtually no set up.

In at least one embodiment, the present invention provides a system including two distance measurement sensors and an angle measurement sensor, allowing for the measurement of the distance between two points in 3-dimensional space, through the use of the Cosine Law. By knowing the lengths of two legs of a triangle as well as the angle between them, the length of the third side can be found via mathematical calculation.

In at least one embodiment, the invention provides a system for measuring the distance between two points in 3-dimensional space including a hinge that allows for angular variance of the two distance sensors relative to one another. This hinge, connected to both distance measurement sensors, permits adjustment of the angle between the two sensors across a range from 0° to 180°. An angle measurement sensor, operating in conjunction with the hinge, can measure the varying angle between the two distance measurement sensors.

In at least one embodiment, the hinge is directly connected to two hollow enclosures, each containing a distance measurement sensor as well as other electronics that promote operation of the device. These enclosures can rotate with the hinge, enabling variance of the angle between the two enclosures and the electronics they contain.

In at least one embodiment, the distance measurement sensors and the angle measurement sensor transmit signals to a microprocessor that is positioned within one of the two enclosures. The microprocessor, configured to receive signals from these measurement devices, can perform the necessary calculations utilizing the Cosine Law to determine the distance between two points in 3-dimensional space. These calculations, along with other relevant information, can optionally be output from the microprocessor to a display that can be viewed by the user.

In at least one embodiment, the microprocessor, configured to receive signals from the two distance measurement sensors as well as the angle measurement sensor, can perform other analysis techniques, determining information such as, but not limited to, arc length, surface area, and volume.

In another respect, the invention provides a method of determining the distance between two points in 3-dimensional space utilizing a device including two distance measurement sensors connected to a hinge that is movable between 0° and 180°; an angle measurement sensor connected to and operating synchronously with the hinge; a microprocessor configured to receive and analyze signals from the two distance measurement sensors and the angle measurement sensor and to provide optional output. The method includes the steps of: determination of the distance from each distance measurement sensor to a certain point in 3-dimensional space; determination of the angle between the two distance measurement sensors by the angle measurement sensor; analysis of the received data to determine the distance between the two points in 3-dimensional space, or some other relevant calculation, such as arc length, surface area, and volume; outputting analysis results for user interpretation.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of an exemplary system in accordance with an embodiment of the invention in a closed, non-operational condition.

FIG. 2 is a perspective view similar to FIG. 1 with the system in an open, non-operational condition between 0° and 180°.

FIG. 3 is a perspective view similar to FIG. 2 with the system in an open, operational condition between 0° and 180°, as the distance measurement sensors determine their respective distances from two points in 3-dimensional space and as the angle measurement sensor determines the hinged angle between the two distance measurement sensors.

FIG. 4 illustrates an exemplary electrical circuit embedded within the hollow cavities of the system.

FIG. 5 is an exploded perspective view of an exemplary system.

FIG. 6 is a rear perspective view of an exemplary system in accordance with the invention in a closed, non-operational condition.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

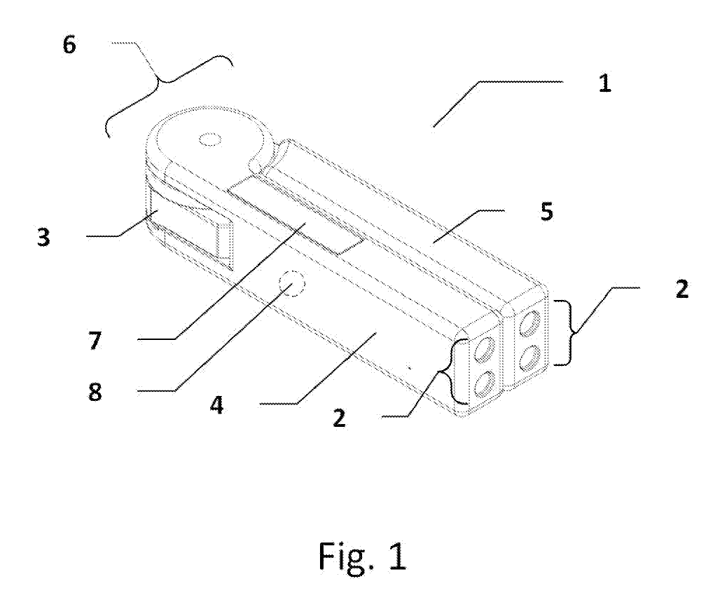

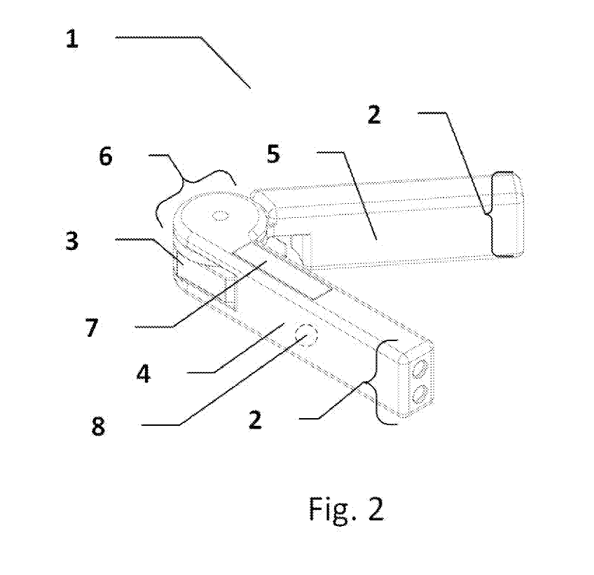

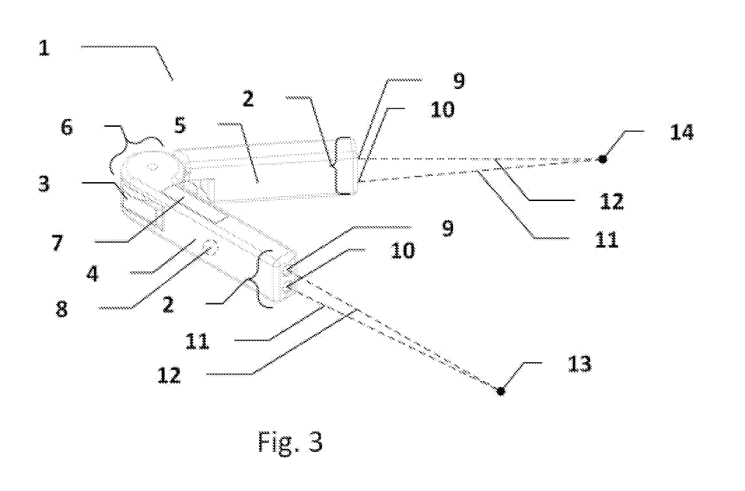

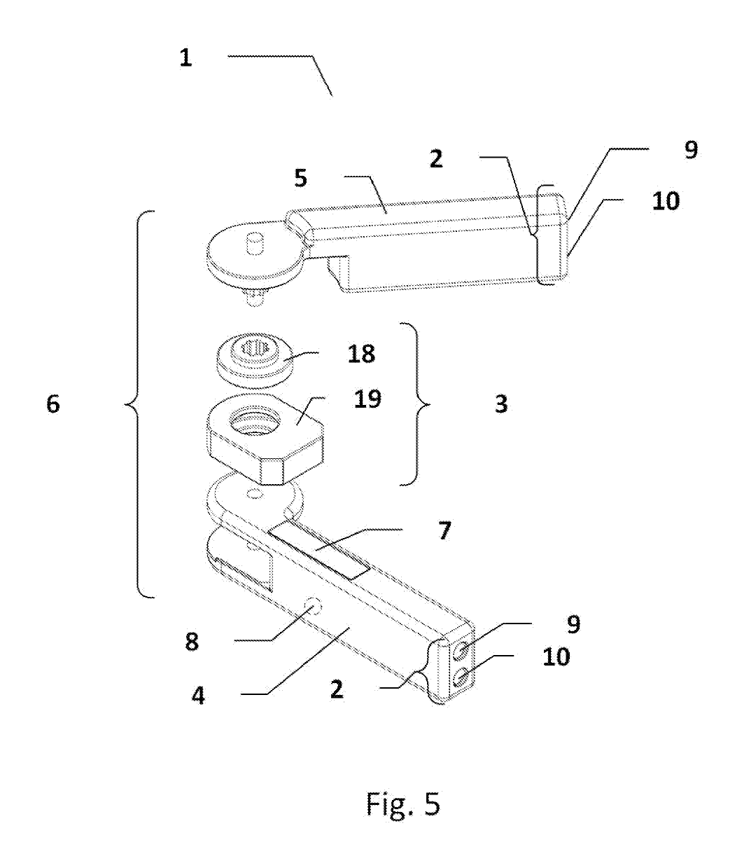

A system 1 in accordance with an exemplary embodiment of the present invention is illustrated in FIGS. 1-6. Referring to FIGS. 1 and 5, the system 1 generally comprises two distance measurement sensors 2 and an angle measurement sensor 3. Each distance measurement sensor 2 is connected to a hollow enclosure 4 and 5, and the hollow enclosures 4 and 5 are joined by a hinge 6 that is pivotal between 0°, illustrated in FIG. 1, and 180°. While the illustrated embodiment pivots between 0° and 180°, the invention is not limited to such and other ranges may be utilized. The system is illustrated in FIG. 3 in an opened and operational state. Each distance measurement sensor 2 comprises a wave transmitter 9, which can emit a frequency wave, and a receiver 10, which can receive the backscattered wave. In operation, each wave transmitter 9 of its respective distance measurement sensor 2 emits an outgoing frequency wave 12. The frequency waves impact two respective points residing on surfaces in 3-Dimensional space 13 and 14, and backscattered waves 11 are reflected from the contact points 13 and 14. These backscattered waves are detected and analyzed by the receivers 10 of each respective distance measurement sensor 2, and with proper data analysis, the distances between the distance measurement sensors 2 and the points in 3-dimensional space 13 and 14 can be determined.

Each distance measurement sensor 2 generally senses in a direction parallel to the respective hollow enclosure 4, 5 such that the angle between the hollow enclosures 4, 5 is representative of the angle between the distance measurement sensors 2. It is recognized that the distance measurement sensors 2 may be otherwise positioned relative to the enclosures 4, 5 and the system 1 configured to adjust for such positioning.

Operating in parallel with this distance measurement process, an angle measurement sensor 3 determines the hinged angle between the distance measurement sensors 2. Data from the distance measurement sensors and the angle measurement sensor are sent to a microcontroller, for example, stored in one of the hollow enclosures 4, for further analysis and display as discussed in more detail hereinafter.

The angle measurement sensor 3 is affixed to one of the hollow enclosures 4 and is concentric to the hinge 6 such that it can determine the angle between the two enclosures 4,5 and thereby between the two distance measurement sensors 2. The angle measurement sensor comprises a base unit 19 affixed to the hollow enclosure 4, as well as a rotatable shaft 18 connected to the hinge 6. While the illustrated embodiment of the angle measurement sensor 3 includes a rotary encoder it is understood that other electronic or electromechanical devices may be utilized to measure the angle and provide such data to the processor of the microcontroller.

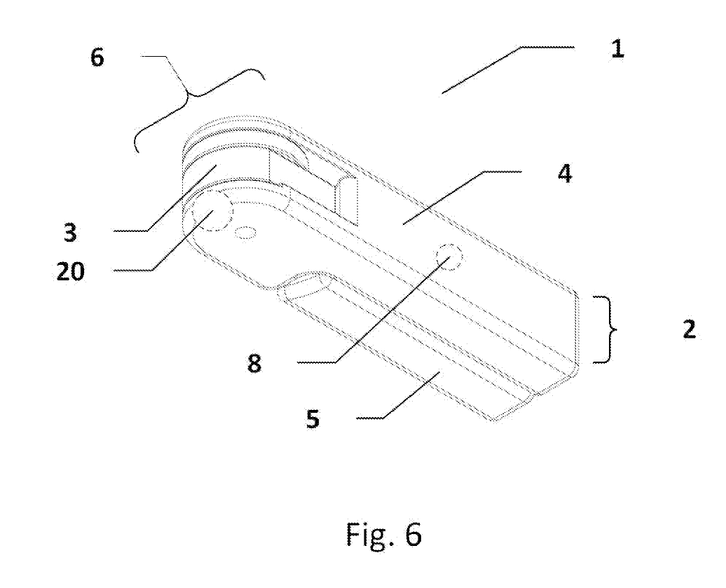

The system may also include an optional display screen 7 to output measurements and other useful information, and an optional power port 8 for recharging the device. As illustrated in FIG. 6, the system may also include an optional mounting device such that the system may be connected to a tripod in order to stabilize the device during operation and to promote ease of use.

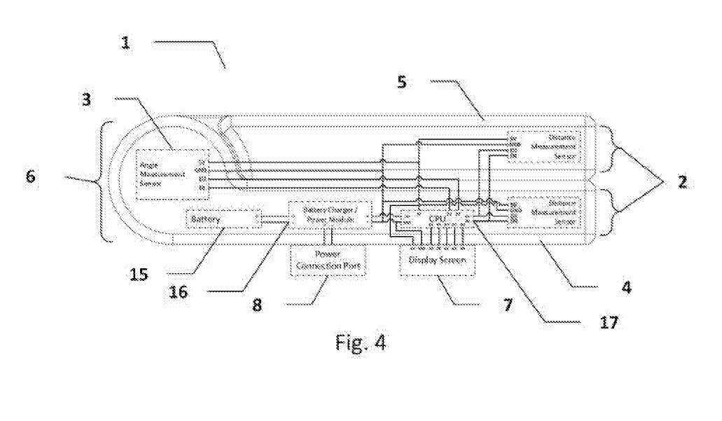

As illustrated in FIG. 4, the microcontroller 17 is configured to receive data signals from the two distance measurement sensors 2 as well as an angle measurement sensor 3. Through the use of a variation of the Cosine Law, the distance between the two points in question can be determined. It should be noted that this modified version of the Cosine Law accounts for the fact that the intersection of two extended rays, parallel to the laser distance measurement sensors 2, does not necessarily occur at the hinge of the device, but will vary along the perpendicular bisector of the hinged angle.

Referring to FIG. 4, the exemplary system 1 is power by a DC input connected to the power connection port 8 as well as a battery 15. Due to the operation of a power management module 16, when a DC input is connected to the power connection port 8, the DC input supplies DC power to both the battery 15 as well as the microcontroller 17. If a DC input is not present, the battery 15 supplies DC power to the microcontroller 17. However, it is understood that other power configurations and sources, for example solar power, may be utilized. The microcontroller 17 is connected to and configured to send and receive data from the angle measurement sensor 3, as well as two distance measurement sensors 2. The microcontroller 17 is also connected to and configured to send data to the display screen 7.

The system and method described herein provide the ability to measure the distance between two points on one or more surfaces in 3-dimensional space, utilizing two distance measurement sensors as well as an angle measurement sensor. With this system and method, it becomes possible to measure the distance between two points in 3-dimensional space from any location, provided a direct line-of-sight to both points. This ease of use is not present with current laser rangefinders, which require the user to station oneself at one of the two points in order to measure the distance. Furthermore, if both points are physically inaccessible, the present system and method can still determine the distance between the two points, while a traditional laser rangefinder would be useless. While several implementations of traditional laser rangefinder technology allow for the measurement of vertical distance, this feature has limited applicability in comparison to the benefits presented by the present system and method.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A device for providing point-to-point distance measurement between any two points on a surface or surfaces in 3-Dimensions comprising:
two laser distance measuring rangefinders,
a rotary encoder that measures the relative angular displacement of the two rangefinders; and
a processor configured to receive data from the two laser distance measuring rangefinders and the rotary encoder and determine a distance between two points based on the received data.

2. The system of claim 1 wherein each rangefinder comprises at least a wave transmitter that emits a frequency wave and a wave receiver that receives and analyzes the backscattered wave.

3. The system of claim 1 wherein each rangefinder relays information of distance measurement to the processor.

4. The system of claim 1 wherein the rotary encoder relays information of angular displacement measurement of the two rangefinders relative to one another to the processor.

5. The system of claim 1 wherein each rangefinder is positioned within a respective hollow enclosure and the processor is in the form of a microcontroller within at least one of the hollow enclosures.

6. The system of claim 5 wherein the processor relays a final calculation of point-to-point distance to a display screen.

7. The system of claim 6 wherein the display screen is positioned on one of the hollow enclosures.

8. The system of claim 1 wherein the processor draws power from a battery or an external power source.

9. The system of claim 1 including an optional mounting device such that the system may be connected to a tripod in order to stabilize the device during operation and to promote ease of use.

10. A method of determining the point-to-point distance measurement between two points on a surface or surfaces, comprising:
measuring a distance from a first laser distance measurement rangefinder to a first of the two points;
measuring a distance from a second laser distance measurement rangefinder to a second of the two points;
measuring an angle between the first and second rangefinders utilizing a rotary encoder; and
calculating the point-to-point distance based on the measured distances and angle.

11. The method of claim 10 wherein the calculation of the final point-to-point distance involves a mathematical calculation including a variation of the Cosine Law.

12. The method of claim 11 further comprising calculating one or more of an arc length, a surface area, or a volume based on the measured distances and angle.
